(19) United States
(12) Patent Application Publication
(10) Pub. No.: US 2007/0267265 A1
(43) Pub. Date: Nov. 22, 2007

(54) Clutch arrangement

(75) Inventors: Jorg Sudau, Niederwerm (DE); Peter Fenn, Waigolshausen (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/800,648

(22) Filed: May 7, 2007

(30) Foreign Application Priority Data
May 18, 2006 (DE) 10 2006 023 288.7

(51) Int. Cl. F16D 11/00

(52) U.S. Cl. 192/53.1

(57) ABSTRACT

A clutch arrangement has a clutch device with a clutch housing capable of rotating around an axis of rotation, where the clutch device is designed to establish or to separate a working connection between a drive and a take-off and is provided with clutch components in the form of a piston and clutch elements. The piston produces a seal between a pressure space and a cooling space holding the clutch elements. The pressure space or the cooling space is connected to a supply unit so that it can be supplied with fluid medium, by connecting at least one supply line of the clutch device is connected to an infeed line of a gearbox and possibly by connecting at least one discharge line of the clutch device is connected to an outfeed line of the gearbox. An actuating line for a first supply line is assigned to the clutch device. The first supply line is independent of the infeed line for a second supply line or of the outfeed line for a discharge line.

### BACKGROUND OF THE INVENTION

1. Field of the Invention

The invention pertains to a clutch arrangement for installation between a drive and a gearbox, the arrangement including a clutch housing which can rotate about an axis of rotation; a clutch including a piston and clutch elements which can be engaged to provide a working connection between the drive and the gearbox, the piston separating a pressure space and a cooling space in which the clutch elements are installed; and a fluid supply unit connected to one of the spaces by a supply line.

2. Description of the Related Art

A clutch arrangement of this type is known from US 2005/224308. This clutch arrangement has a clutch device with a clutch housing capable of rotating around an axis of rotation and is used to establish a working connection between a drive such as a crankshaft of an internal combustion engine and a take-off such as a gearbox input shaft when certain clutch components are in the engaged position and to separate the take-off from the drive when the clutch components are in the disengaged position. The clutch components are in the form of a piston and in the form of drive-side clutch elements and takeoff-side clutch elements, where the piston is used to create a seal between a pressure space and a cooling space, the clutch elements being installed in the latter. The cooling space, like the pressure space, is connected to a supply station by a supply line so that the space can be supplied with fluid medium. The supply station is provided on the side of the clutch housing facing away from the drive. Each of these supply lines of the clutch device is connected to an infeed line of the gearbox, whereas a discharge line of the clutch device assigned to the cooling space is connected to an outfeed line of the gearbox.

The supply lines for the pressure space and for the cooling space and the discharge line for the cooling space are realized either in the immediate radial area of the axis of rotation or the form of a central bore passing through the gearbox input shaft and also in the area radially just outside the axis of rotation in the form of ring-shaped channels, where a first channel extends radially between a clutch housing hub and a stationary support shaft, located in a gearbox housing of the gearbox surrounding the clutch housing, and where a second channel extends radially between this support shaft and the gearbox input shaft.

These types of clutch devices, in which the pressure space can be filled with fluid medium from the supply basis by way of a first supply line and the cooling space can be filled by way of a second supply line, and in which, furthermore, the cooling space also has a discharge line for fluid medium, so that this medium can be returned to a fluid reservoir, are referred to in professional circles as “three-line systems”. The clutch arrangement is usually supplied by means of a hydraulic pump, which is driven by the take-off, i.e., by the gearbox input shaft. This pump therefore acts as the supply basis. Thus, a gearbox which is used to supply a clutch arrangement designed as a three-line system must always have two infeed lines, one for each supply line of the clutch arrangement, and also an outfeed line for a discharge line of the clutch arrangement. For cost reasons, however, gearboxes acting in this way are used only to a limited extent in motor vehicles, especially in passenger vehicles. Instead, the gearboxes used in passenger vehicles are usually suitable for being combined with a clutch arrangement designed as a two-line system and thus provide only one infeed line for the supply line of the clutch arrangement and one outfeed line for the discharge line of the clutch arrangement, regardless of the design of the clutch arrangement, which can be realized as a hydrodynamic torque converter as described in U.S. Pat. No. 5,575,363 or as a clutch device such as that discussed in DE 101 51 632 A1. The essential feature but also the essential disadvantage of the two-line systems is that there is always a flow connection for the fluid medium between the pressure space and the cooling space. It is true that, when the clutch arrangement is engaged, the flow passing through this connection is not as great as that which occurs when the clutch arrangement is disengaged, but nevertheless the accuracy with which the clutch can be controlled is worse and the behavior during the engaging and disengaging processes is more sluggish.

To return to US 2005/224308, the pressure space in this design is located on the side of the piston facing the drive, whereas the cooling space is located on the side of the piston facing away from the drive. Because the supply basis is on the gearbox side, the supply line for the pressure space is relatively long. It must therefore be assumed that there will be a not inconsiderable pressure loss between the supply basis and the pressure space. This could perhaps still be tolerated in the case of a hydrodynamic torque converter such as that described in U.S. Pat. No. 5,575,363 because of the large diameter of the piston and thus its larger pressure actuation surface, but in the case of a clutch device according to US 2005/224308, the pressure provided in the pressure space can simply be insufficient for the prompt displacement of the piston to engage the clutch arrangement. Therefore, a higher pressure level must be made available by the supply basis, as a result of which it appears unavoidable that a higher power demand must be imposed on the drive of the motor vehicle.

### SUMMARY OF THE INVENTION

According to the invention, a clutch arrangement is designed so that the arrangement can be combined with a gearbox which is designed as a two-line system without the need to deal with the disadvantages normally encountered in a two-line system. Alternatively, it should also be possible for a drive to supply two lines.

By designing the clutch device of the clutch arrangement with a pressure space and cooling space, which is separated from the pressure space by a piston acting as a clutch component and which is designed to hold at least one clutch element also serving as a clutch component, by connecting the pressure space to a supply line, and by connecting the cooling space preferably both to a supply line and to a discharge line, it is ensured, first, that the pressure space can be supplied promptly with fluid medium so that the pressure can be built up rapidly and thus the piston can be displaced quickly and controlled with optimal sensitivity, and, second, that the cooling space can also be supplied promptly with fluid medium so that the heat can be carried away rapidly from the friction area of the clutch elements. The supply lines here are thus lines which are in working connection with infeed lines, which are assigned to a drive and/or to a gearbox, and which are connected either to a supply basis assigned to the drive or to the gearbox or are connected to a supply source independent of this supply basis, where the supply basis and the supply source are parts of a supply system which can be influenced by an open-loop and/or closed-loop control unit. When the supply basis is assigned to the gearbox, the supply basis will be, for example, a hydraulic pump, which can be driven by the gearbox input shaft. The discharge line, however, is in working connection with an outfeed line assigned to the drive or to the gearbox. This outfeed line makes it possible for the fluid medium which may have become heated to leave the cooling space, preferably, and to return to a fluid reservoir, where the latter can be in working connection with the supply basis and/or with the supply source, preferably by means of an intermediate cooler for the fluid medium arriving from the cooling space.

The prompt supply of the pressure space and the also prompt supply and discharge of the cooling space with sufficient volume flow rates of fresh fluid medium are accomplished in each case by means of an admittedly simple, but nevertheless positive embodiment of the clutch arrangement characterized both by the advantageous location of the supply lines and the discharge line and by the advantageous positioning of the pressure space and cooling space with respect to the gearbox and thus with respect to the supply basis and/or supply source, as will be explained below.

The location of the lines will be explained first. The inventive layout of the lines makes it possible for only two lines, i.e., one supply line and one discharge line, for example, to be connected to the corresponding lines of a drive or of gearbox, that is, to one infeed line and one outfeed line. The components of the drive or gearbox can thus be designed in each case for a two-line system. A third line, referred to below as the “actuating line”, supplements functionally the two previously mentioned lines of the drive or gearbox but is positioned independently of these two lines and can also, if desired, be supplied with fluid medium independently of these two lines. So that the actuating line can be supplied independently of the other two lines, the actuating line can be connected preferably to a supply source which is independent of the supply basis of the two other lines. The actuating line, however, should be supplied in coordination with the supply or discharge of the two other lines, for which reason the supply source and the supply basis can be connected to the open-loop and/or closed-loop control unit which controls both parts of the supply system. Alternatively, however, the actuating line can be connected along with the other two lines to a common supply basis of the gearbox.

In summary, therefore, it is of essential importance for the supply of the spaces of the clutch arrangement that the lines which characterize the drive or the gearbox as a two-line system be supplemented by an actuating line which is independent of the other two lines. This actuating line, however, can be not only functionally separate from the other two lines, as previously mentioned, but can also be spatially separated from them. For example, at least one of the lines characterizing the gearbox as a two-line system can preferably be located either in the immediate area of the axis of rotation of the clutch arrangement, preferably in the radial area of a central bore passing axially through the take-off, i.e., the gearbox input shaft, and/or at least one of these lines is located radially just outside the axis of rotation, preferably radially between the gearbox input shaft and a support shaft permanently connected to the gearbox and/or radially between the support shaft and a clutch housing hub of the clutch arrangement. The supply and discharge lines connected to these lines are positioned appropriately in the clutch arrangement, i.e., in a close spatial relationship with these lines. As a result, the various lines are concentrated in an area only a short radial distance away from the axis of rotation of the clutch arrangement both in the gearbox and in the clutch housing, so that the flow effects induced by centrifugal force can be minimized, and it is also ensured that the clutch arrangement can be compact in spite of the presence of all these lines. Because the additional actuating line and also the supply line assigned to it are separate from these lines, they can be positioned wherever desired in the gearbox and/or in the clutch housing. The actuating line, however, is preferably integrated into the gearbox housing of the gearbox and is thus stationary.

Insofar as the supply unit, especially in this case the supply source, as well as the actuating line are provided on the side of the clutch arrangement facing the gearbox, it is advantageous for the pressure space, which is to be actuated in comparably short periods of time with relatively high pressures under open-loop and/or closed-loop control, to be provided also on the side of the clutch arrangement facing the gearbox. As a result, the length of the corresponding supply line can be decreased, and thus not only the complexity of the layout of the lines through which the fluid is guided is reduced but also in particular the losses caused by flow resistance are decreased. This in turn makes it possible for the supply source to be designed with a comparatively modest power capacity, for which reason only a limited power demand must be imposed on the drive, i.e., on the internal combustion engine. As a result of locating the pressure space in this way, the cooling space will be located on the side of the clutch facing the drive, and if the cooling space is equipped with a torsional vibration damper, the damper will also be located there.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows an elementary connection diagram of a drive train with a drive, a clutch arrangement, and a gearbox; and

FIG. 2 shows a cross section through the clutch arrangement, which has a clutch device inside a clutch housing.

### DETAILED DESCRIPTION OF THE PRESENTLY PREFERRED EMBODIMENTS

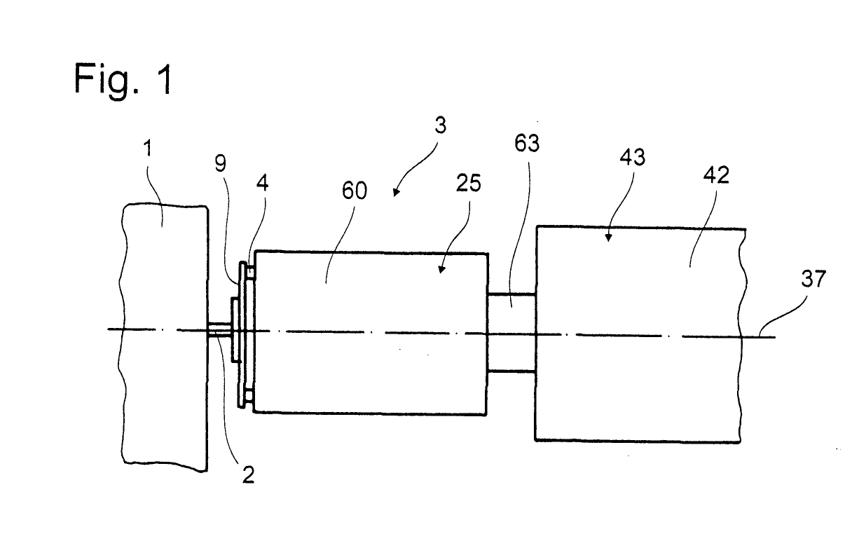

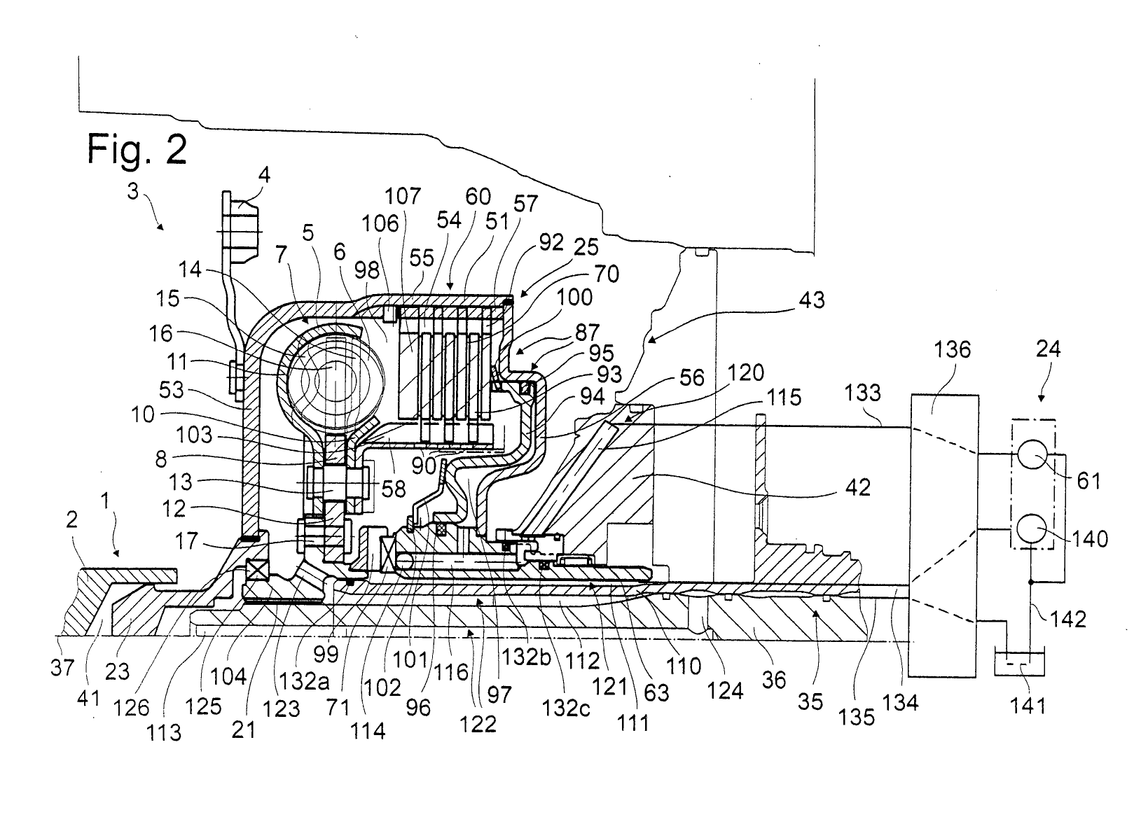

FIG. 1 shows a schematic diagram of a drive train 3 rotating around an axis of rotation 37 and provided with an inventive clutch arrangement 25. The clutch arrangement 25 includes a clutch housing 60, which can be connected for rotation in common to a drive 1, such as the crankshaft 2 of an internal combustion engine, by means of a plurality of fastening elements 4 and a connecting element 9 such as a flexplate. On the axial side facing away from the drive 1, the clutch housing 60 has a clutch housing hub 63, which engages, for example, in a gearbox 43 and there drives in rotation the supply basis 140, shown only schematically in FIG. 2, of a supply unit 24, where the supply unit 24 can also be designed with a supply source 61. A take-off 35 in the form of a gearbox input shaft 36 is concentric to the clutch housing hub 63. The free end of the shaft projects into the clutch housing 60.

FIG. 2 shows a bearing journal 23 assigned to the clutch housing 60. The journal engages in a recess 41 in the crankshaft 2. A drive-side radial housing wall 53 is attached to this bearing journal 23; the radially outer area of this wall merges with an axial housing wall 55. The free takeoff-side of this axial housing wall 55 holds a takeoff-side radial housing wall 56 in nonrotatable, sealed fashion, where the two radial housing walls 53, 56 and the axial housing wall 55 together form the previously mentioned clutch housing 60 of a clutch device 54. The takeoff-side radial housing arrangement 56 is permanently connected to a clutch housing hub 63, on which a piston 94 is mounted with freedom of axial movement. This piston 94 separates a pressure space 97 of the clutch device 54 from a cooling space 98 of the clutch device 54 and is provided on its radially outer edge with a seal 95 to ensure the desired protection from leakage. On the radially inner edge, which cooperates with the clutch housing hub 63, however, the piston is provided with a seal 96. The piston 94 cooperates with the radially outer drive-side clutch elements 92 and the radially inner takeoff-side clutch elements 93 to form the clutch components 87 of the clutch device 54.

The drive-side clutch elements 92 are connected nonrotatably to a drive-side clutch element carrier 51, by means of a set of teeth 57. The carrier is formed essentially by the bearing journal 23, the drive-side radial housing wall 53, and the axial housing wall 55. These clutch elements 92 can be brought into working connection with the takeoff-side clutch elements 93 by means of a friction area 70, where the takeoff-side clutch elements 93 are connected nonrotatably to a takeoff-side clutch element carrier 103 of the clutch device 54 by a set of teeth 58. The takeoff-side clutch element carrier 103 is connected nonrotatably to two cover plates 10, 11 by means of rivets 13, where these cover plates 10, 11 have drive-side control elements 14, 15, to actuate an energy-storage set 6 extending in the circumferential direction, which is supported at the other end in the circumferential direction against a takeoff-side control element 16 provided on a hub disk 12. The hub disk 12 is attached by rivets 17 to a hub 104, which is formed with a flow passage 123 and is connected nonrotatably to the gearbox input shaft 36 by a set of teeth 21. The hub 104 is supported both in the axial and in the radial direction against the bearing journal 23 by a bearing 125 and is thus supported on the drive side by the journal 23 engaging in the recess 41. The bearing 125 therefore acts with respect to the transmission input shaft 36 as a pilot bearing 126, which centers the shaft.

The cover plates 10, 11 form the drive-side transmission element 5 of the torsional vibration damper 7; the cover plate 11 extends around most of the circumference of the energy-storage set 6. The hub disk 12, however, forms the takeoff-side transmission element 8 of the torsional vibration damper 7. The torsional vibration damper 7 is effective in the case of torsional vibrations which are not to be transmitted from the drive 1 via the drive-side clutch element carrier 51 and the drive-side clutch elements 92 to the takeoff-side clutch elements 93 and from there via the takeoff-side clutch element carrier 103 to the hub 104 and thus to the take-off 35. Accordingly, the hub 104 functions as a torsional vibration damper hub and simultaneously as a takeoff-side clutch element carrier hub. In addition, the hub 104 has a bearing 71 acting in the axial direction, which has a flow passage 99. This bearing enables the hub to position the clutch housing hub 63 axially with respect to the drive 1. A line 116, which is closed off at its drive-side end by a plug 114, passes through the clutch housing hub 63. The line 116 is connected to a line 115, formed in the gearbox housing 42 of the gearbox 43.

The clutch device 54 is in its engaged position when the piston 94, which has a contact-inducing energy storage device 100, which is intended to make the engaging process proceed more “softly”, is transmitting axial pressure to the clutch elements 92, 93, so that these elements arrive in friction-locking contact with each other via their friction area 70 and are supported against an end stop 106 by way of a last plate 107. The end stop is formed by a back-up ring axially secured by means of a positive connection to the axial housing wall 55. The clutch device 54 is in its released position, however, when the axial pressure exerted by the piston 94 is reduced to such an extent that the friction-locking connection between the clutch elements 92, 93 acting in the friction area 70 has been at least essentially disconnected.

The piston 94 has an axial energy storage device 101, which is supported at one end against the piston 94 and at the other end against a retainer 102, permanently connected to the clutch housing hub 63. This energy storage device is used to exert force on the piston 94 in the direction toward the takeoff-side radial wall 56 of the clutch device 54. The goal of this measure is to prevent the piston 94 from making undesirable contact with the axially adjacent clutch element 92 and thus to prevent the maintenance of a friction-locking connection—undesirable in the released position—between the clutch elements 92 and 93, and ultimately, therefore to prevent the clutch device 54 from transmitting any torque.

As FIG. 2 clearly shows, a supply unit 24 is provided on the takeoff-side of the clutch arrangement 25. This unit is connected to the clutch arrangement 25 to supply it with fluid medium and to take that medium away again, namely, under the control of an open-loop and/or closed-loop control unit 136. The supply unit 24 has a supply station 140, which in this case is a fluid delivery pump assigned to the gearbox 43 and driven by the gearbox input shaft 36. Supplementally, the supply unit 24 can also have a supply source 61, which can be independent of the supply station 140 both spatially and functionally. In the present case, the supply station 140 and the supply source 61 are connected separately from each other via the open-loop and/or closed-loop control unit 136 to lines, where an actuating line 133 is assigned to the supply source 61, and an infeed line 134, leading from the gearbox 43 to the clutch device 54 and an outfeed line 135, leading from the clutch device 54 to the gearbox 43, are assigned to the supply station 140. The outfeed line 135 is in fluid connection with a fluid reservoir 141. The fluid reservoir 141 is itself in fluid connection via a connecting line 142 with the supply basis 140 and/or with the supply source 61. Alternatively, the supply source 61 can also have its own external reservoir for fluid medium independent of the fluid reservoir 141 of the supply station 140.

Of the various lines, only the infeed line 134 and the outfeed line 135 are permanently assigned to the gearbox 43, which means that the gearbox 43 acts as a two-line system. Consequently, there are also only two lines in the clutch device assigned to the two lines 134 and 135. The first of these is a supply line 121 for filling the cooling space 98 with fluid medium. This supply line comprises a first ring-shaped channel 111, located between the clutch housing hub 63 and the support shaft 110, which is permanently connected to the gearbox, and the flow passage 99 for the cooling space 98. The second of these lines is a discharge line 122, comprising the second ring-shaped channel 112, located between the support shaft 110 and the gearbox input shaft 36, and the flow passage 123 in the hub 104, for carrying away the fluid medium present in the cooling space 98. Alternatively or in addition, the second of these lines can also comprise the central bore 113 and the radial connection 124 in the gearbox input shaft 36 and also the bearing 126, which establishes a flow connection with the cooling space 98. The actuating line 133, however, is connected to a supply line 120, which consists of the lines 115 and 116. This supply line leads to the pressure space 97 and thus serves to fill the latter. For the sake of clarity, the supply line 120 is referred to in the following as the “first” supply line, and the supply line 121 is referred to as the “second” supply line.

So that fluid medium can flow through the cooling space 98 of the clutch device 54, a flow connection is established between the second supply line 121 and the supply station 140 by the control unit 136. If flow openings 90 for supplying the friction area 70 of the clutch device 54 have in fact been provided in the takeoff-side clutch element carrier 103, the fluid medium which has entered the cooling space 98 will be conveyed radially outward and through these flow openings 90 under the effect of pressure and centrifugal force. If the clutch element carrier 103 has been designed without flow openings 90, the fluid medium flows radially outward at least essentially along the piston 94 instead to the friction area 70 of the clutch device 54. After flowing through this friction area 70, the fluid medium is deflected first in the axial direction along the set of teeth 57 of the drive-side clutch element carrier 51 and then radially inward. After traveling radially inward in the axial area between the drive-side radial housing wall 53 of the clutch housing 60 and the drive-side cover plate 11 of the torsional vibration damper 7, the fluid reaches the hub 104, where it passes through the bearing 65 and also through the flow passage 123, so that in this way it leaves the cooling space 98 again. Thus the fluid medium returns via the discharge line 122 and the outfeed line 135 to the open-loop and/or closed-loop control unit 136, and from there it returns to the fluid reservoir 141. The fluid medium can then flow, possibly after intermediate cooling, from the reservoir via the connecting line 142 back to the supply basis 140 and thus becomes available to the infeed line 134 and can be used to fill the supply line 121 again.

The pressure space 97 used to engage the clutch device 54 is fed with fluid medium from the supply source 61 in a different way, namely, via the open-loop and/or closed-loop control unit 136, the actuating line 133, and the first supply line 120. The actuating line 133 is in this case just as independent of the gearbox-based infeed line 134 as the first supply line 120 is of the second supply line 121. The pressure in the pressure space 97 can therefore be increased without the need to use one of the lines assigned to the gearbox 43, namely, either the infeed line 134 or the outfeed line 135. The actuating line 133 inside the gearbox housing 42 is also spatially separate from the infeed and outfeed lines 134, 135 inside the gearbox, a separation which also applies to the arrangement of the first supply line 120, cooperating with the actuating line 133, inside the clutch device 54. As can be seen in FIG. 2, the first supply line 120 with its line 115 extends radially inward over a considerable distance from the radially outer area, but its radially inner end is nevertheless still radially outside the second supply line 121 and also radially outside the discharge line 122.

Of course, the individual supply lines 120 and 121 must be isolated in a fluid-tight manner from each other but also from the discharge line 122, for which reason seals 132a-132c are provided at the appropriate points. FIG. 2 shows a first seal 132a located radially between the support shaft 110 and the hub 104 of the torsional vibration damper 7 and/or of the takeoff-side clutch element carrier 103. In addition, second seals 132b and 132c are provided, each of which is located radially between the clutch housing hub 63 and the gearbox housing 42 of the gearbox 43. The seal 132b acts in this case essentially to prevent the loss of fluid medium in the radially outward direction, whereas the seal 132c acts essentially as a seal in the axial direction.

FIG. 2, moreover, shows that the clutch arrangement 25, in a departure from the state of the art such as the solutions known from the previously cited US 2005/224308, is installed in a laterally reversed manner with respect to the drive 1 and the take-off 35, i.e., according to the invention the components are arranged piston—clutch—damper. Because the supply unit 24 is on the takeoff-side, the result is that there is a very short first supply line 120 between the supply unit 24 and the pressure space 97 and thus very low overall losses in the first supply line. This means that pistons 94 with small radial dimensions can be moved quickly and sensitively to engage the clutch device 54. As a result of this type of installation, furthermore, advantages are also obtained with respect to the centering of the torsional vibration damper 7 and of the takeoff-side clutch element carrier 103 with respect to the drive 1.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A clutch arrangement for installation between a drive and a gearbox, the arrangement comprising:
a clutch housing which can rotate about an axis of rotation;
a clutch comprising a piston and clutch elements which can be engaged to provide a working connection between the drive and the gearbox, the piston separating a pressure space and a cooling space in which the clutch elements are installed;
a fluid supply unit;
a first supply line connected to one of said spaces;
an actuating line connecting said first supply line to said fluid supply unit;
a second supply line connected to the other of said spaces;
an infeed line connecting said second supply line to said fluid supply unit, wherein the infeed line is independent of the actuating line;
a discharge line connected to the other of said spaces; and
an outfeed line connecting the discharge line to said fluid supply unit, wherein the outfeed line is independent of the actuating line.

2. The clutch arrangement of claim 1 wherein the fluid supply unit comprises a supply source and a supply station, the actuating line being connected to the supply source, the arrangement further comprising a control unit which operates the actuating line independently of the supply station.

3. The clutch arrangement of claim 1 wherein the fluid supply unit comprises a supply source and a supply station, the actuating line being connected to the supply source, the arrangement further comprising a control unit which can connect the supply source to the supply station.

4. The clutch arrangement of claim 1 wherein the actuating line is spatially separate from the infeed line and from the outfeed line.

5. The clutch arrangement of claim 4 wherein the first supply line is spatially separate from the second supply line and the discharge line.

6. The clutch arrangement of claim 1 wherein the second supply line and the discharge line are in radial proximity to the axis of rotation, whereas the actuation line can be positioned relatively remotely from the axis of rotation.

7. The clutch arrangement of claim 6 wherein the first supply line extends into the clutch housing.

8. The clutch arrangement of claim 1 wherein said pressure space and said cooling space are arranged at different distances from said fluid supply source, the first supply line being connected to the space closer to the fluid supply source, the second supply line being connected to the space farther from the supply source.

9. The clutch arrangement of claim 8 wherein said fluid supply source is positioned adjacent to said clutch housing oppositely from said drive, the pressure space being closer to the fluid supply source than the cooling space.

10. The clutch arrangement of claim 1 further comprising a gearbox housing, wherein part of one of said supply lines is integrated into said gearbox housing.

11. The clutch arrangement of claim 1 wherein said clutch comprises a drive side clutch element carrier which is connected non-rotatably to the drive, and a takeoff side clutch element carrier connected to a hub which is connected non-rotatably to a takeoff, the clutch housing having a bearing journal which centers the hub.

12. The clutch arrangement of claim 11 further comprising a bearing which centers the hub in the bearing journal.

13. The clutch arrangement of claim 11 further comprising a torsional vibration damper between the takeoff side clutch element carrier and the hub.

14. The clutch arrangement of claim 13 wherein the torsional vibration damper is located between the clutch elements and the drive, the piston being located on a side of the clutch elements facing away from the drive.

15. The clutch arrangement of claim 11 wherein the clutch housing comprises a drive-side radial housing wall, an axial housing wall, and a takeoff side radial housing wall, wherein the drive-side radial housing wall is mounted on the bearing journal.

16. The clutch arrangement of claim 15 wherein the axial housing wall is formed with teeth, the clutch elements comprising drive-side clutch elements which engage said teeth.

17. The clutch arrangement of claim 15 wherein the takeoff side radial housing wall comprises a clutch housing hub which is centered in a gearbox housing.

18. The clutch arrangement of claim 17 further comprising a support shaft, the clutch housing hub surrounding the support shaft to form a first annular channel forming one of said second supply line and said discharge line.

19. The clutch arrangement of claim 17 wherein the support shaft surrounds a gearbox input shaft to form a second ring-shaped channel forming one of said second supply line and said discharge line.

20. The clutch arrangement of claim 15 wherein the piston and the drive-side radial housing wall form axial boundaries of the cooling space, and the piston and the takeoff side radial housing wall form axial boundaries of the pressure space.

21. The clutch arrangement of claim 17 wherein the piston is mounted on the clutch housing hub with freedom to move axially, the arrangement further comprising a spring supported on the clutch housing hub and urging the piston away from the clutch elements.

22. The clutch arrangement of claim 1 further comprising a gearbox housing, the clutch housing comprising a clutch housing hub, the first supply line comprising a first part in said gearbox housing and a second part in said clutch housing hub.

23. The clutch arrangement of claim 22 wherein the second part of said first clutch supply line has a drive-side end which is fitted with a plug.

24. The clutch arrangement of claim 18 wherein the first annular channel serves as said second supply line.

25. The clutch arrangement of claim 19 wherein the second supply line comprises said second annular channel and a line in the hub of said takeoff side clutch element carrier.

26. The clutch arrangement of claim 25 wherein said second supply line further comprises a central bore in said gearbox input shaft and a radial connection connecting said central bore to said second annular channel.

27. The clutch arrangement of claim 1 further comprising seals isolating the first and second supply lines from each other and from the discharge line.

28. The clutch arrangement of claim 27 further comprising a support shaft and one of a torsional vibration damper having a hub and a takeoff side clutch element carrier having a hub, the seals comprising a first seal located radially between the support shaft and the hub of said one of said torsional vibration damper and said takeoff side clutch element carrier.

29. The clutch arrangement of claim 27 further comprising a clutch housing hub and a gearbox housing, the seals comprising second seals radially between the clutch housing hub and the gearbox housing.

30. The clutch arrangement of claim 11 wherein the bearing journal has a recess which receives a gearbox input shaft.
